(19) United States
(12) Patent Application Publication
(10) Pub. No.: US 2007/0242007 A1
(43) Pub. Date: Oct. 18, 2007

(54) ACTIVE MATRIX ORGANIC LED DISPLAY AND DRIVING METHOD THEREOF

(76) Inventors: I-Shu Lee, Taoyuan (TW); Wen-Fa Hsu, Taoyuan (TW); Yu-Yuan Chang, Taoyuan (TW)

Correspondence Address: NORTH AMERICA INTELLECTUAL PROPERTY CORPORATION, P.O. BOX 506, MERRIFIELD, VA, 22116, US

(21) Appl. No.: 11/548,702

(22) Filed: Oct. 12, 2006

(30) Foreign Application Priority Data
Apr. 17, 2006 (TW) 095113666

(51) Int. Cl. G09G 3/32

(52) U.S. Cl. 345/82

(57) ABSTRACT

A display capable of adjusting its driving circuits according to an input resolution includes an active organic light emitting unit, a time data controller, a gate driving circuit and a source driving circuit. The time data controller includes a video data determining unit for determining a resolution of received video data and outputting a determination signal, and a controller for generating a data signal and a control signal according to the determination signal. The gate driving circuit is coupled to the time data controller and the plurality of scan lines, utilized to drive gates of pixels according to the control signal. The source driving circuit is coupled to the time data controller and the plurality of data lines, utilized to drive sources of pixels according to the data signal.

### BACKGROUND OF THE INVENTION

1. Field of the Invention

The present invention relates to a display and its related driving method. More particularly, the present invention describes an active matrix OLED display for adjusting its drive circuit according to its resolution and a related driving method.

2. Description of the Prior Art

Flat panel displays offer the advantages of increased power-savings, reduced size, and elimination of radiation when compared to a traditional cathode ray tube (CRT) display. Therefore, the CRT display is being gradually replaced by flat panel displays. With the progression of flat panel displays, flat panel industries are devoted to improving techniques to increase market benefits. An example is a display using an organic light emitting diode (OLED), which produces a higher luminosity, higher emitting efficiency, higher contrast, shorter response time, wider viewing angle, lower power consumption, and wider operable temperature range when compared to an LED.

OLEDs are current-driven components, with their emitting luminosity directly proportional to the applied current. Matrix displays include passive matrix displays and active matrix displays. The passive matrix display adopts the method sequentially driving the scan lines to drive the pixels on the same row one-by-one. After the pixels on the same row are driven, then the pixels on the next row are driven one-by-one. Thus the emitting time of a pixel on each position is limited by the scan frequency and the amount of scan lines on the display. For a large display with high resolution, this may not be an appropriate method. The active matrix display comprises an individual pixel circuit within each pixel. Each pixel circuit contains a storage capacitor, an OLED component, and two thin-film transistors (TFTs) used to adjust the size of the OLED driving current. Therefore, even when used for a large display with high resolution, the active matrix display still provides each pixel with a stable driving current to improve light uniformity of the display.

However, when an active OLED display shows an image with a lower resolution than that display with, the power of the active OLED display is wasted because it is not necessary to enable all the pixel circuits of the active OLED display. FIG. 1 is a diagram of a conventional active matrix OLED display 100 with the resolution of 1024×768. In FIG. 1, the image data with a resolution of 1024×768 is displayed on the conventional active matrix OLED display 100 and represented as area 10, which is also the entire display range of the display. The image data with a resolution of 640×480 is displayed on the conventional active matrix OLED display 100 and represented as area 1 2. When the conventional active matrix OLED display 100 receives a valid data with the resolution of 640×480, though the conventional active matrix OLED display 100 has no data to display outside the area 1 2, the conventional active matrix OLED display 100 still sends the control signals with the resolution of 1024×768, which means that the gate driving circuit still sends 768 gate clocks while the data driving circuit still turns on 1024×3 data lines (each pixel has 3 sub-pixels of different colors). However, as shown in FIG. 1, the image data of resolution 640×480 has no valid data on scan lines c0 to c142and c642 to c767 but on scan lines c143 to c623. Therefore, when the conventional active matrix OLED display 100 drives scan lines c0 to c142, and scan lines c624 to 767, the power of the display 100 is wasted because those pixels with invalid image data are driven as well. Similarly, when the active matrix OLED display 100 drives data lines d0 to d191, and data lines d832 to d1023, invalid image data of grey level 0 are sent as well. This is also the same situation with DVD videos which of the image data have narrower heights in widescreen versions. Only a middle portion of the screen is used, while the upper and the lower part of the screen remain black.

As the described above, when receiving the image data of the resolution lower than the resolution of a conventional active matrix OLED display, the conventional active matrix OLED display still enables the gate driving circuits and the source driving circuits of the unused areas, causing power wasting.

### SUMMARY OF THE INVENTION

The present invention provides a display capable of adjusting driving circuits according to a resolution of video data. The display comprises: an active organic light emitting unit, which additionally comprises: a plurality of pixel areas each formed by a plurality of data lines interwoven with a plurality of scan lines, wherein each pixel area comprises a first switch and a pixel circuit, the first switch comprising: a first end coupled to one of the plurality of scan lines; a second end coupled to one of the plurality of data lines; and a third end coupled to the pixel circuit; a time data controller for receiving video data and a time signal comprising: a video data determining unit for determining the resolution of the video data and outputting a determination signal; and a first source and gate time data controller coupled to the video data determining unit, for receiving the determination signal in order to generate a data signal and a control signal; a gate driving circuit, coupled to the time data controller and the plurality of scan lines, receiving the control signals to drive the first end; and a source driving circuit coupled to the time data control circuit and the plurality of data lines for receiving the data signals to drive the second end.

The present invention also provides a driving method for adjusting an active matrix OLED display according to a resolution of video data. The method comprises the following steps: (a) receiving video data with a time data controller of the display; (b) determining the resolution of the video data with the time data controller of the display; and (c) driving a gate driving circuit and a source driving circuit of the display according to the resolution of video data as determined by the time data controller of the display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional active matrix OLED display.

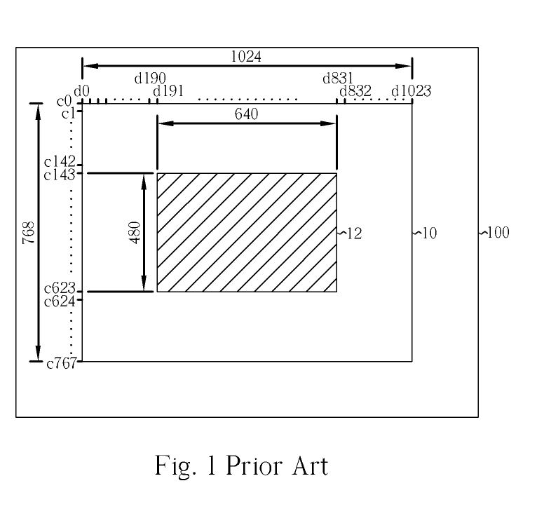

FIG. 2 is a flowchart illustrating a driving method adjusting the driving circuits of the display according to the resolution of the present invention.

FIG. 3 is a diagram illustrating an active matrix OLED display adjusting its drive circuits according to the resolution of the present invention.

FIG. 4 is a diagram illustrating a first embodiment of the clock data control circuit of the present invention.

FIG. 5 is a diagram illustrating the second embodiment of the clock data control circuit of the present invention.

### DETAILED DESCRIPTION

The present invention therefore provides a display capable of adjusting driving circuits according to an input resolution. This allows the display to only enable its gate driving circuits and source driving circuits corresponding to the resolution of the input image data. In this way, those gate and source driving circuits with invalid image data are not enabled.

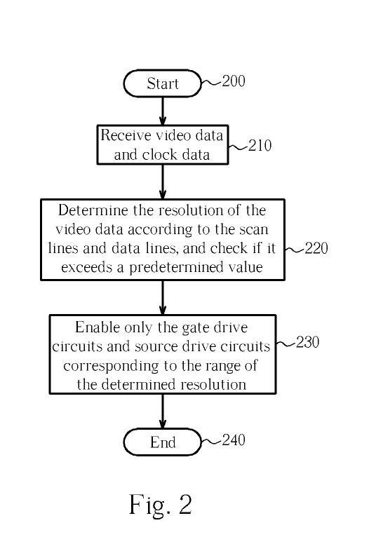

FIG. 2 is a flowchart illustrating the driving method of the display according to an input resolution.

Step 200: Start;

Step 210: Receive video data and clock data;

Step 220: Determine the resolution of the video data according to the scan lines and data lines, and check if it exceeds a predetermined value.

Step 230: enable only the gate driving circuits and source driving circuits corresponding to the range of the determined resolution.

Step 240: End.

When the display of the present invention receives the video data, the display first detects the valid range of the video data (i.e. determines the resolution of the video data), and then enables corresponding gate driving circuits and source driving circuits. Step 220 determines the valid data by comparison of the grey level value of the pixels. For example, if the grey level values of the all pixels outside of a certain range are lower than a predetermined value, then that range can be selected as a valid area, while the area outside the range is selected to be invalid. Also, a corresponding resolution can be determined by checking if the grey level value of each pixel in the received video data exceeds a predetermined value. Since the invalid display area is distinguished, the driving method of the present invention does not enable the gate driving circuits of the scan lines corresponding to the invalid display area, and does not input video data to the source driving circuits of the data lines corresponding to the invalid display area. Only the gate driving circuits of the scan lines corresponding to the valid display area are enabled, and only the source driving circuits of the data lines corresponding to the valid display area are used.

When brought into practice, the method of the present invention described in FIG. 2 can examine resolutions through inspecting a predetermined amount of frames. After checking out a predetermined amount of frames, the resolution of the video data is determined and step 220 ceases. The received video data is then directly executed in step 230. Step 230 can also include generating a new control clock to enable gate driving circuits of scan lines within the valid display area, according to the determined resolution. For example, if the determined resolution is 640×480, the step 230 generates 480 gate clock control signals in each frame for driving the corresponding gate control circuits.

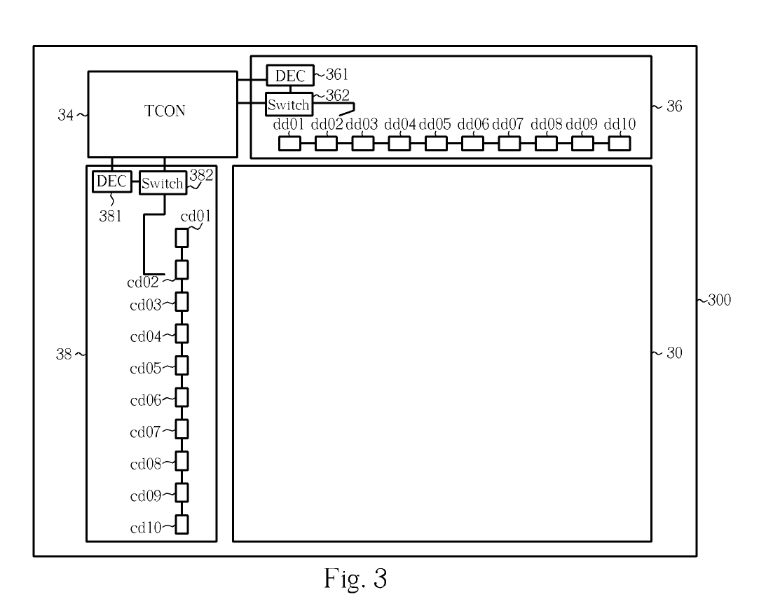

FIG. 3 is a diagram illustrating an embodiment of the active matrix OLED display 300 of the present invention, used to adjust driving circuits according to an input resolution. According to the embodiment in FIG. 3, the active matrix OLED display 300 contains 768 scan lines and 1024 data lines, and thus the maximum display area 30 has a resolution of 1024×768. The active matrix OLED display 300 receives video data and clock signals through a clock data control circuit 34, which analyzes and determines the valid resolution of the received video data. It then outputs the result to the source driving circuit 36 and the gate driving circuit 38. The source driving circuit 36 contains a decoder 361, a switch 362, and data-line-drive chips dd01 to dd10, responsible for driving each data line of the display 300. The source driving circuit 36 receives video data and the resolution of received video data from the clock data control circuit 34. The decoder 361 generates a source selection signal to the switch 362 according to the resolution result. One end of the switch 362 is coupled to the clock data control circuit 34 while the other end is coupled to one of the data-line-drive chips from dd01 to dd10. According to the source selection signal input, the decoder 361 selects the data-line-drive chip that corresponds to the start data line of the determined resolution so that data signals from the clock data control circuit 34 are transmitted to the start data line of the valid display area when displaying video data. Similarly, the gate drive circuit 38 contains a decoder 381, a switch 382, and scan-line-drive chips cd01 to cd10 which are responsible for driving each scan line of the display 300. The gate driving circuit 38 receives control signals and the resolution result of the video data from clock data control circuit 34. The decoder 381 generates a gate selection signal to switch 382 according to the result. One end of the switch 382 is coupled to the clock data control circuit 34 while the other end of the switch 382 is coupled to one of the scan-line-drive chips cd01 to cd10. According to the gate selection signal from the decoder 381, the starting scan line corresponds to the determined resolution. Control signals from the clock data control circuit 34 are transmitted to the start data line to enable gates of the pixel circuit within the valid display area, and enable the corresponding data lines to display the input video data. The display 300 can alternatively be adopted to include multiplexers as another embodiment, where the amount of data-line-drive chips can be different since those described in FIG. 3.

As an example, it is assumed that an active matrix OLED display 300 of the present invention has a resolution of 1024×768 and it receives the video data of the resolution 640×480. The clock data control circuit 34 determines the resolution of the video data to be 640×480 according to the grey level values of the pixels outside of the valid display range being lower than a minimum value. Because this differs from the display resolution of 1024×768, the clock data control circuit 34 transmits the result to the gate driving circuit 38 and the source driving circuit 36. After receiving the result, the decoder of the gate driving circuit 38 controls the switch 382 to connect to the scan-line-drive chip corresponding to the start line of the valid display range of resolution 640×480 (i.e., the fifth scan line of the second scan-line-drive chip cd02 of the gate driving circuit 38 can be chosen for example). The gate driving circuit 38 can use the control clock corresponding to the resolution determined by the clock data control circuit 34 to consecutively enable the 143^{rd} to 623^{rd} scan lines. In this way, the gate driving circuit 38 of the present invention scans through 480 horizontal lines per frame, corresponding to the 640×480 input resolution, by enabling only the 143^{rd} to 623^{rd} scan lines within the valid display range. Alternatively, after receiving the resolution result from the clock data control circuit 34, the decoder of the source driving circuit 36 controls the switch 362 to connect to the data-line-drive chip corresponding to the start data line of the valid display range. For example, we assume that the output of the 15^{th} data line of the data-line-drive chip dd03 of the source driving circuit 36. Video data from the clock data control circuit 34, which is the video data for display within the valid display range, can be transmitted to data-line-drive chip dd03 corresponding to the start data line, and then continuously displayed from the 191^{st} to the 831^{st} data line one after another. That is, the source driving circuit 38 of the present invention only enables 640×3 data signals, corresponding from the 191^{st} to the 831^{st} data lines within the valid display range.

It is shown from the embodiment described above that when compared with the prior art, the display adjusting driving circuits of the present invention reduce power consumption more effectively. In contrast, the display of the prior art continually enables 768 times per frame and turns on 1024×3 data signals when only a 640×480 resolution is required, needlessly wasting power.

To utilize the driving method of the present invention, gate driving circuits and source driving circuits have to be designed as shown in FIG. 3 so that the display chooses the start data line and the start scan line of the valid display area. The clock data control circuit is also essential to the present invention.

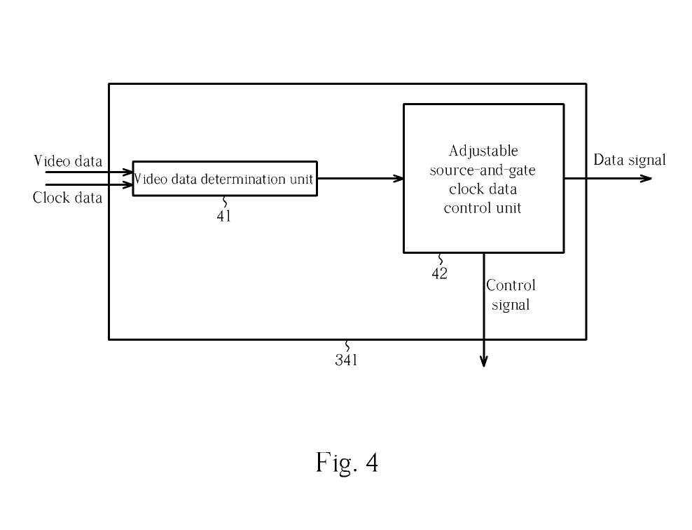

FIG. 4 is a diagram illustrating a first embodiment of the clock data control circuit 341 of the present invention. The clock data control circuit 341 of the present invention contains a video data determination unit 41 and an adjustable source-and-gate clock data control unit 42. The clock data control circuit 341 receives video data and clock data. The video data determination unit 41 determines the resolution of the received video data and transmits the result to the adjustable source-and-gate clock data control unit 42. The adjustable source-and-gate clock data control unit 42 is coupled to the video data determination unit 41, and chooses the specific data lines and specific scan lines corresponding to the valid display area of the resolution according to the resolution result. It also generates the control signals and data signals to the pixel circuits coupled to the specific scan lines and the specific data lines. The clock data control circuit 341 of the present invention transmits the adjusted data signals from the adjustable source-and-gate clock data control unit 42 to the source driving circuit of the display for displaying the corresponding image data within the valid image range, and transmits the adjusted control signals from the adjustable source-and-gate clock data control unit 42 to the gate driving circuit of the display for only activating the scan lines corresponding to the valid image range.

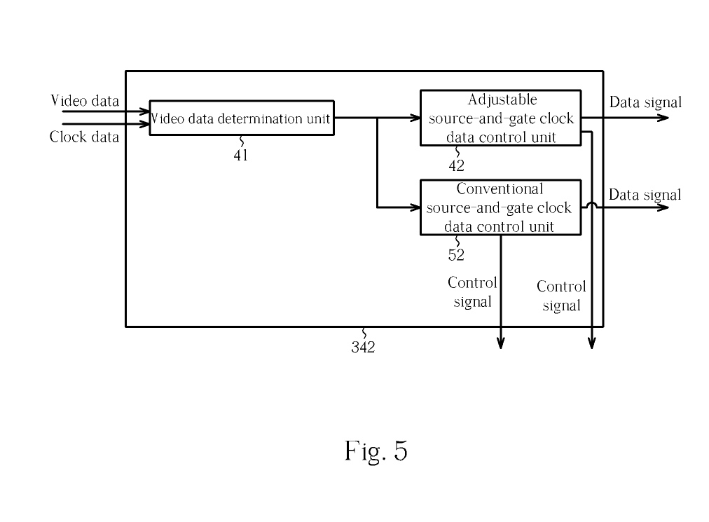

The present invention also contains an adjustable source-and-gate clock data control unit together with a conventional source-and-gate clock data control unit. FIG. 5 is a diagram illustrating the second embodiment of the clock data control circuit 342 of the present invention. In this embodiment, aside from containing a video data determination unit 41 and an adjustable source-and-gate clock data control unit 42, the clock data control circuit 342 also contains a conventional source-and-gate clock data control unit 52. When the video data determination unit 41 determines the resolution of the video data, the result of the resolution is additionally output to the conventional source-and-gate clock data control unit 52. The conventional source-and-gate clock data control unit 52 outputs control signals and the data signals in the same manner as the prior art, enabling the whole scan lines of the display, and outputting the received video data from the whole data lines of the display. However, when the video data determination unit 41 determines the corresponding data resolution is not the same as the display, the video data determination unit 41 outputs the resolution result to the adjustable source-and-gate clock data control unit 42. The adjustable source-and-gate clock data control unit 42 chooses the specific data lines and the specific scan lines corresponding to the valid display area and the data resolution, and generates control signals and data signals for the pixel circuits coupled to the specific scan lines and the specific data lines. Then it transmits them to the gate driving circuits and the source driving circuits, respectively, to only enable the scan lines corresponding to the valid image range and solely display the image data corresponding to the valid image range.

In summary, the present invention provides a display capable of adjusting its driving circuits according to an input resolution. When the resolution of video data is lower than that of the display, the present invention prevents display of areas outside of the input data resolution. This is accomplished by not enabling the gate driving circuits and the source driving circuits corresponding to the invalid display area so that the power consumption of the display is effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display capable of adjusting driving circuits according to a resolution comprising:
an active organic light emitting display unit including:
a plurality of pixel areas, constructed by a plurality of data lines interwoven with a plurality of scan lines, each pixel area including a first switch and a pixel circuit, the first switch including:
a first end coupled to one scan line of the plurality of scan lines;
a second end coupled to one data line of the plurality of data lines; and
a third end coupled to the pixel circuit;
a time data controller for receiving video data and a time signal, comprising:
a video data determining unit for determining a resolution of the video data and outputting a determination signal; and
a first source and gate time data controller, coupled to the video data determining unit, for receiving the determination signal to generate a data signal and a control signal;
a gate driving circuit, coupled to the time data controller and the plurality of scan lines receiving the control signal, for driving the first end of the pixel circuit; and
a source driving circuit, coupled to the time data control circuit and the plurality of data lines receiving the data signals, for driving the second end of the pixel circuit.

2. The display of claim 1, wherein the time data controller further comprises:
a second source and gate time data controller, coupled to the video data determining unit receiving the determination signal, for generating the control signals and data signals of all pixel circuits of the active organic light emitting display unit;
wherein the video data determining unit outputs signals to the first source and gate time data controller, and to the second source and gate time data controller according to the received video data.

3. The display of claim 1, wherein the gate driving circuit comprises:
a decoder for generating a gate selection signal according to the time data controller; and
a switch including:
a first end coupled to the time data controller; and
a second end, coupled to a scan line, for transmitting the control signal output by the time data controller to the scan line according to the gate selection signal.

4. The display of claim 1, wherein the source driving circuit comprises:
a decoder for generating a source selection signal according to the time data controller;
and
a switch including:
a first end coupled to the time data controller; and
a second end, coupled to a data line, for transmitting the data signal output by the time data controller to the data line according to the source selection signal.

5. The display of claim 1, wherein the pixel circuit comprises:
a second switch having a first end coupled to a first power supply, and a second end coupled to the third end of the first switch;
a storing capacitor having a first end coupled to the third end of the first switch, and a second end coupled to a ground voltage, the storing capacitor being charged by a current of a corresponding data line when the first switch is on; and
a light unit, coupled between a third end of the second switch and a second power supply, for displaying images according to the current.

6. The display of claim 5, wherein the first switch and the second switch comprise thin-film transistors.

7. The display of claim 5, wherein the light unit comprises an organic light emitting diode.

8. A drive method for adjusting an active matrix OLED display according to a resolution of video data, comprising the following steps:
(a) receiving video data through a time data controller of the display;
(b) determining the resolution of the video data with the time data controller of the display; and
(c) driving a gate driving circuit and a source driving circuit of the display according to the resolution of the video data as determined by the time data controller of the display.

9. The method of claim 8, wherein the step (b) comprises determining the resolution of the video data according to a plurality of scan lines and data lines having gray levels higher than a predetermined value.

10. The method of claim 8, wherein the step (b) comprises determining the resolution of the video data by checking if gray levels of the received video data are higher than a predetermined value pixel-by-pixel.

11. The method of claim 8, wherein the step (b) comprises determining the resolution of the video data according to a resolution of a predetermined number of frames.

12. The method of claim 8, wherein the step (a) comprises receiving a clock signal by the time data controller of the display, and the step (c) comprises generating by the time data controller a clock signal corresponding to the resolution of video data according to the resolution and the received clock signal.

13. The method of claim 8, wherein the step (c) comprises driving a portion of the pixel circuits of the display, by the time data controller, according to the resolution of video data.

14. The method of claim 8, wherein the step (c) comprises rearranging data clocks, by the time data controller, according to the resolution of video data.

15. The method of claim 14, wherein the step (c) further comprises generating a control signal, by the time data controller, to drive a gate driving circuit of the display according to the resolution of video data.
